(19) United States
(12) Patent Application Publication
(10) Pub. No.: US 2025/0202148 A1
(43) Pub. Date: Jun. 19, 2025

(54) Angled End Of A Round Contact

(71) Applicant: HIRSCHMANN AUTOMOTIVE GMBH, Rankweil/Brederis (AT)

(72) Inventors: Andreas METZLER, Muntlix (Zwischenwasser) (AT); Simon DÜNSER, Bludenz (AT)

(21) Appl. No.: 18/843,500

(22) PCT Filed: Apr. 25, 2023
(86) PCT No.: PCT/EP2023/060792

§ 371 Date: Sep. 3, 2024

(30) Foreign Application Priority Data
Apr. 26, 2022 (DE) 10 2022 110 018.9

(51) Int. Cl. H01R 13/11

(52) U.S. Cl. CPC H01R 13/11

(57) ABSTRACT

The invention relates to a contact partner, in particular designed as a socket contact, which can be connected to a pin contact to form a plug connection, wherein the socket contact is designed as a punched-out and rolled part and has a contact region as well as a connection zone, in particular a crimped region, wherein the contact region is formed by a main body with a peripheral housing and two spaced-apart rings are provided within the housing, which are connected to one another via at least one elongated contact spring, wherein one end of the main body is connected to the connection zone, via a transition region, at an angle within a range of between 85° and 95° (in relation to the longitudinal axis of the main body).

The invention relates to a contact partner of a plug connector, in particular designed as a socket contact, which can be connected to a pin contact to form a plug connection, wherein the socket contact is designed as a punched-out and rolled part and has a contact region as well as a connection zone, in particular a crimped region, wherein the contact region is formed by a main body with a peripheral housing and two spaced-apart rings are provided within the housing, which are connected to one another via at least one elongated contact spring, according to the features of the preamble of claim 1.

Such a contact partner, designed as a socket contact, is known from DE 10 2015 213 674 A1.

The known socket contact can be connected to a pin contact to form a plug connection, wherein the socket contact is designed as a punched-out and rolled part and has a contact region as well as a connection zone, in particular a crimped region, wherein the contact region is formed by a main body with a peripheral housing and two spaced-apart rings are provided within the housing, which are connected to one another via at least one elongated contact spring. The pin contact is inserted into the contact region within the main body, which pin contact is then electrically contacted with the at least one contact spring. In this prior art, a plurality of contact springs are present within the main body, which contact springs extend between the two rings. At the connection zone, the contact partner is connected to an electrical conductor of a cable. The invention is carried out, for example, by soldering, welding, crimping or a comparable and equivalent connection technique.

The invention is based on the object of improving this contact partner.

This object is achieved by the features of claim 1.

The object is achieved according to the invention in that one end of the main body is connected to the connection zone, via a transition region, at an angle within a range of between 85° and 95° (in relation to the longitudinal axis of the main body, preferably at a 90° angle).

According to the invention, an angled end, in particular a 90° end, is thus realized for the contact partner, in particular a round contact, preferably a stamped and bent part, without subsequent bends, wherein the outlet of the rear end of the main body is used to realize a homogeneous transition without cross-sectional reductions. According to a further embodiment of the invention, this can be achieved in that the main body, the transition region and the connection zone are formed as a one-piece component.

Further alternative or supplementary embodiments of the invention are shown in the drawings and the associated description.

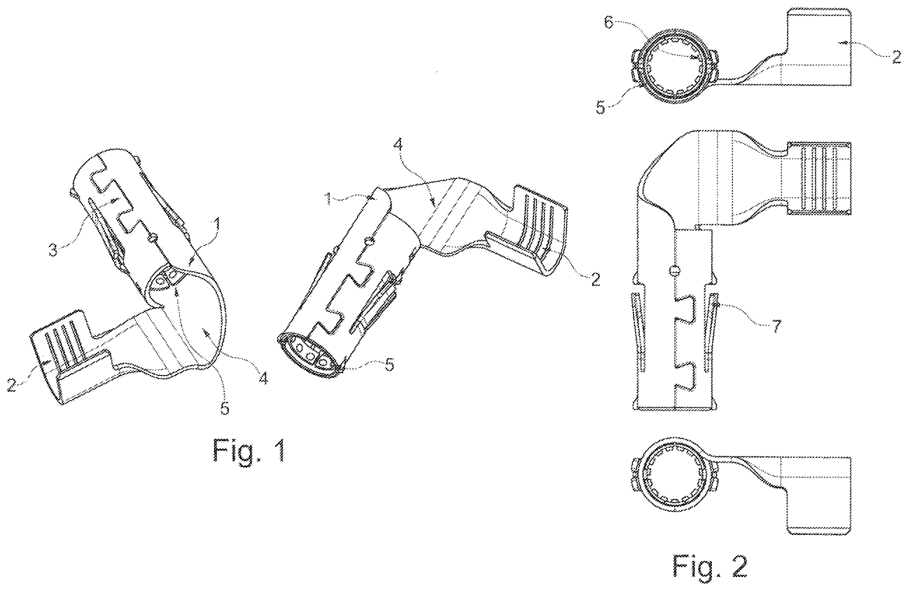

A contact partner according to the invention, formed as a round contact, is shown in various views in FIGS. 1 and 2 and described below.

The contact partner has a main body 1. The main body 1 is made of a flat, electrically conductive material, which is formed into the approximately cylindrical main body 1 in a stamping and rolling method. Furthermore, the contact partner has a connection zone 2. At the connection zone 2, the contact partner is connected to an electrical conductor (not shown). The connection can be made, for example, by welding, soldering, crimping or the like. After the deformation of the main body 1, the lateral longitudinal edges thereof are in abutment 3 with one another. The course of the abutment 3 can be straight or, as shown, a tongue-and-groove course.

According to the invention, the rear end of the main body 1 and the connection zone 2 are connected to one another via a transition region 4. The main body 1, the transition region 4 and the connection zone 2 are formed as a one-piece component. This means that said component can preferably be manufactured automatically using a stamping and bending or stamping and rolling method.

The transition between the main body 1 and the connection zone 2, formed by the transition region 4, is between 85° and 95° (in relation to the longitudinal axis of the main body) and is preferably equal to or as close as possible to 90°.

According to the invention, a 90° angled end is thus realized in a round contact (stamped and bent part) without subsequent bending. The outlet of the rear end of the main body 1 is used so that a homogeneous transition can be realized without cross-sectional reductions. The connection zone 2 for the cable, more precisely the electrical conductor thereof, is independent of the angled end and can, for example, also be designed as a welding lug.

Within the main body 1 of the contact partner, two rings 5 are arranged at a distance from one another, wherein one ring is arranged at the front end of the main body 1 and the other ring 5 at the rear end of the main body 1, which the transition region 4 adjoins. There is at least one contact spring between the two spaced-apart rings 5. In the embodiment according to the invention, a plurality of contact springs 6 (see FIG. 2, upper illustration) are present circumferentially, running parallel to one another. The contact springs 6 together with the two rings 5 form a contact cage, which is inserted into the main body 1 and optionally fixed (for example by pressing, soldering, welding or the like). In its interior, the contact cage and thus the contact partner with the rear angled end according to the invention accommodates the contact pin (not shown) of a mating plug connector.

If the contact partner shown in FIGS. 1 and 2 is to be inserted into a housing (or into a contact chamber of a contact carrier) of the plug connector and locked in its position, the main body 1 can have at least one latching tab 7 which forms a locking mechanism, in particular a primary locking mechanism, within the housing (or within the contact chamber). In the central illustration of FIG. 2 it can be seen that two latching tabs 7 protrude diametrically from the main body 1.

The main body 1, the transition region 4 and the connection zone 2, if they are manufactured as separate components before being joined together, consist of identical or different materials that are electrically conductive. If two of these components or all three components are realized as one-piece components, they are of course made of the same electrically conductive material.

### LIST OF REFERENCE SIGNS

1. Main body
2. Connection zone
5 3. Abutment
4. Transition region
5. Ring
6. Contact spring
7. Latching tab

1.-5. (canceled)

6. A contact partner configured as a socket contact that can be connected to a pin contact to form a plug connection, wherein the socket contact is configured as a punched-out and rolled part and comprises a contact region and a connection zone, wherein the contact region is formed by a main body with a peripheral housing and two spaced-apart rings are provided within the peripheral housing, which are connected to one another via at least one elongated contact spring, wherein one end of the main body is connected to the connection zone, via a transition region, at an angle within a range of between 85° and 95° (in relation to the longitudinal axis of the main body).

7. The contact partner according to claim 6, wherein one end of the main body is connected, via the transition region, to the connection zone at a 90° angle (in relation to the longitudinal axis of the main body).

8. The contact partner according to claim 6, wherein the main body, the transition region, and the connection zone are formed as a one-piece component.

9. The contact partner according to claim 6, wherein the mutually facing lateral ends of the main body are arranged so as to be in abutment with one another.

10. The contact partner according to claim 9, wherein the mutually facing lateral ends of the main body are at least partially inseparably connected to one another.

11. The contact partner according to claim 6, wherein the contact partner is a socket contact.

12. The contact partner according to claim 6, wherein the connection zone is a crimped region.

13. A socket contact connectable to a pin contact to form a plug connection, wherein the socket contact is configured as a punched-out and rolled part, the socket contact comprising:
a connection zone; and
a contact region formed by a main body with a peripheral housing and two spaced-apart rings within the peripheral housing, the two spaced-apart rings connected to one another via at least one elongated contact spring;
wherein one end of the main body is connected to the connection zone, via a transition region, at an angle within a range of between 85° and 95° (in relation to the longitudinal axis of the main body).

14. The socket contact according to claim 13, wherein one end of the main body is connected, via the transition region, to the connection zone at a 90° angle (in relation to the longitudinal axis of the main body).

15. The socket contact according to claim 13, wherein the main body, the transition region, and the connection zone are formed as a one-piece component.

16. The socket contact according to claim 13, wherein the mutually facing lateral ends of the main body are arranged so as to be in abutment with one another.

17. The socket contact according to claim 16, wherein the mutually facing lateral ends of the main body are at least partially inseparably connected to one another.

18. The socket contact according to claim 13, wherein the connection zone is a crimped region.
